(19) United States
(12) Patent Application Publication
(10) Pub. No.: US 2026/0201223 A1
(43) Pub. Date: Jul. 16, 2026

(54) COMPOSITE ELEMENTS OF THERMAL INSULATION MATERIAL, ADHESIVE AND OUTER LAYER

(71) Applicant: BASF SE, Ludwigshafen am Rhein (DE)

(72) Inventors: Olaf JACOBMEIER, Lemfoerde (DE); Sabrina KRONIG, Lemfoerde (DE); Antje HUSKOBLA, Lemfoerde (DE); Christian RENNER, Lemfoerde (DE); Peter HUNTEMANN, Lemfoerde (DE)

(21) Appl. No.: 19/453,026

(22) Filed: Jan. 20, 2026

Related U.S. Application Data
(63) Continuation of application No. 16/966,936, filed on Jan. 30, 2019, now abandoned.

(30) Foreign Application Priority Data
Feb. 7, 2018 (EP) 18155625.9

(51) Int. Cl. C09J 175/08; B32B 5/02; B32B 7/12; B32B 37/12; C08G 18/18; C08G 18/48; C08G 18/76; C08J 9/12; C09J 5/08; C09J 11/04

(52) U.S. Cl. CPC C09J 175/08; B32B 5/02; B32B 7/12; B32B 37/12; C08G 18/1808; C08G 18/4812; C08G 18/4829; C08G 18/4833; C08G 18/7671; C08J 9/125; C09J 5/08; C09J 11/04; B32B 2262/108; B32B 2307/304; C08J 2203/10; C08J 2205/026; C08J 2207/02; C08J 2375/08; C09J 2400/126; C09J 2475/00

(57) ABSTRACT

Described herein is a process for producing composite elements comprising thermal insulation material (B), adhesive (C), and optionally at least one outer layer (A), where the thermal insulation material (B) is bonded with the adhesive (C). Also described herein are composite elements formed from thermal insulation material (B) and adhesive (C) and optionally at least one outer layer (A), producible by such a process. Also described herein is a method of using the adhesive (C) for the bonding of thermal insulation materials (B).

### CROSS-REFERENCE TO RELATED APPLICATIONS

This application is a continuation application of U.S. patent application Ser. No. 16/966,936, filed Aug. 3, 2020, which is a U.S. National Phase Application of PCT/EP19/52175, filed Jan. 30, 2019, which claims the benefit of priority to European Patent Application 18155625.9, filed Feb. 7, 2018, the entire contents of which are hereby incorporated by reference herein.

### FIELD OF INVENTION

The present invention relates to a process for producing composite elements comprising thermal insulation material (B) and adhesive (C) and optionally at least one outer layer (A), where the thermal insulation material (B) is bonded with the adhesive (C) and the adhesive (C) is a polyurethane adhesive preparable by mixing polyisocyanates (a) with polyols (b) having at least two isocyanate-reactive groups, blowing agents (c) comprising water, and optionally chain extenders (d), catalysts (e) and other auxiliaries (f), wherein the polyols (b) comprise polyetherols and the polyetherols comprise 50% to 90% by weight of at least one polyalkylene oxide (b1) having a hydroxyl number of from 120 to 300 mg KOH/g, based on a difunctional starter molecule, and an ethylene oxide content, based on the content of alkylene oxide, of from 60% to 100% by weight, and a proportion of primary OH groups of from 50% to 100%, 10% to 50% by weight of at least one polyalkylene oxide (b2) having a hydroxyl number of from 120 to 600 mg KOH/g, based on a difunctional and/or a trifunctional starter molecule, and an ethylene oxide content, based on the content of alkylene oxide, of from 0% to 40% by weight and 0% to 30% by weight of at least one further polyalkylene oxide (b3) having a hydroxyl number of from 100 to 800 mg KOH/g, based on a difunctional to tetrafunctional starter molecule, based in each case on the total weight of components (b1) to (b3). The present invention further relates to one of composite elements comprising thermal insulation material (B) and adhesive (C) and optionally at least one outer layer (A), producible by such a process.

### BACKGROUND

The production of composite elements from, in particular, metallic outer layers and a core of a thermal insulation material is known. In particular, the production of panels comprising a core of mineral wool, frequently also referred to as mineral wool sandwich elements, on continuously operating twin-belt systems is currently practiced on an ever increasing scale. The essential advantage of such elements, especially those using inorganic insulation materials such as mineral wool or known aerogel materials consists, besides the usability as construction elements, in their high resistance to flame exposure. Mineral wool-based sandwich elements, also referred to as mineral wool sandwich elements, are used in particular for the formation of façades and roofs of a very wide variety of buildings in which very high fire protection is important. Outer layers used here, in addition to coated steel sheets, also include stainless steel sheets, copper sheets, or aluminum sheets. For the bonding of the core materials to each other or to the metallic outer layers, single- or two-component isocyanate-based adhesives have proven useful.

For example, EP 1896259 describes the production of sandwich elements from an outer layer and mineral insulation material, the outer layer and insulation material being bonded with a two-component polyurethane adhesive. In the example, a two-component polyurethane adhesive is used, where in the polyol component a mixture of polyether polyols based on propylene oxide, flame retardant, water, foam stabilizer and amine catalyst is described. This polyol component is reacted with polymeric diphenylmethane to give the adhesive.

Particular attention is paid to the high resistance of the sandwich elements with respect to combustibility. If, for example, outer layers of metal and inorganic insulants as insulation material are used, the only combustible component is the polyurethane adhesive. For this reason, there have been many attempts to reduce the combustibility of the adhesive.

For example, WO 2003051954 discloses the provision of a flame-retardant polyurethane adhesive based on castor oil, propylene oxide-based polyether polyols, fatty acid-containing polyester polyols and additives such as water as blowing agent, catalyst and flame retardant. A disadvantage of these adhesives is in particular a low adhesive effect.

WO2012/091927 describes an adhesive for the production of mineral wool sandwich elements, in which castor oil is replaced by an aromatic polyester diol. This is used in a mixture with a polyether polyol having a functionality of 2 to 4 and a viscosity of up to 500 mPas. In this case, together with a slightly improved adhesion, a lower calorific value of 16 MJ/kg in the filled state (53.55% by weight of calcium carbonate as filler; example 1) and 26.0 MJ/kg in the unfilled state is achieved.

The bonding of aerogel materials or aerogel composites is also known. For example, EP 2665876 describes the use of waterglass solutions as adhesive for the assembly of a plurality of plies of aerogel materials or aerogel composites for the production of an aerogel insulation panel for applications in building insulation. The transverse tensile strengths achieved are very low here and do not allow for standard-conforming use for example in thermal insulation composite systems.

Flame-resistant composite systems are also known comprising one or more layers of aerogel materials and optionally other insulating or non-insulating materials. For the production of these composite elements, it is necessary to bond the thermal insulation materials, for example individual plies or layers of the insulation materials to each other and to bond the insulation materials and any outer layers present. However, the resistance to flame exposure in this case also depends to a substantial degree on the combustibility of the adhesive. For instance, while inorganic, essentially non-combustible adhesives are known, these frequently exhibit only inadequate adhesive properties.

### DETAILED DESCRIPTION

It was an object of the present invention to provide composite elements formed from thermal insulation material (B) and adhesive (C) and optionally at least one outer layer (A), which exhibit a high adhesion of the bond of the thermal insulation material, for example of the bond between various layers of the same or different thermal insulation materials (B) or between the thermal insulation material (B) and the outer layer (A), and in which the adhesive used has a low calorific value. The composite elements should also be producible using a small amount of adhesive.

The object of the invention was surprisingly achieved by a composite element comprising thermal insulation material (B) and adhesive (C) and optionally at least one outer layer (A), producible by a process in which the thermal insulation material (B) is bonded with the adhesive (C) and the adhesive (C) is a polyurethane adhesive preparable by mixing polyisocyanates (a) with polyols (b) having at least two isocyanate-reactive groups, blowing agents (c) comprising water, and optionally chain extenders (d), catalysts (e) and other auxiliaries (f), wherein the polyols (b) comprise polyetherols and the polyetherols comprise 50% to 90% by weight of at least one polyalkylene oxide (b1) having a hydroxyl number of from 120 to 300 mg KOH/g, based on a difunctional starter molecule, and an ethylene oxide content, based on the content of alkylene oxide, of from 60% to 100% by weight, and a proportion of primary OH groups of from 50% to 100%, 10% to 50% by weight of at least one polyalkylene oxide (b2) having a hydroxyl number of from 120 to 600 mg KOH/g, based on a difunctional and/or a trifunctional starter molecule, and an ethylene oxide content, based on the content of alkylene oxide, of from 0% to 40% by weight and 0% to 30% by weight of at least one further polyalkylene oxide (b3) having a hydroxyl number of from 100 to 800 mg KOH/g, based on a difunctional to tetrafunctional starter molecule, based in each case on the total weight of components (b1) to (b3). The present invention further relates to a process for producing the composite element of the invention, in which the thermal insulation material (B) is bonded with the adhesive (C).

For the production of the composite materials in accordance with the present invention, further materials may be used here in addition to the thermal insulation material (B), the adhesive (C) and optionally the outer layer (A). The composite element of the invention preferably consists of thermal insulation material (B), the adhesive (C) and optionally the outer layer (A).

Within the context of the present invention, the bonding of the thermal insulation material (B) encompasses any form of bonding in which the thermal insulation material (B) is in contact with the adhesive (C). This can include the bonding of different plies of the thermal insulation material (B) to each other and also the bonding of the thermal insulation material (B) to other materials, such as for example the outer layer (A).

For the preparation of the adhesive (C), the polyisocyanates (a) used may include any aliphatic, cycloaliphatic and aromatic di- or polyfunctional isocyanates known from the prior art and any desired mixture of these. Aromatic di- or polyfunctional isocyanates are preferably used.

Examples are diphenylmethane 4,4′-, 2,4′-, and 2,2′-diisocyanate (MDI), mixtures of monomeric diphenylmethane diisocyanates and higher polycyclic homologs of diphenylmethane diisocyanate (polymer MDI), tetramethylene diisocyanate, hexamethylene diisocyanate (HDI), isophorone diisocyanate (IPDI), naphthalene 1,5-diisocyanate (NDI), toluene 2,4,6-triisocyanate and toluene 2,4- and 2,6-diisocyanate (TDI), or mixtures thereof.

Particular preference is given to using aromatic isocyanates selected from the group consisting of toluene 2,4-diisocyanate, toluene 2,6-diisocyanate, diphenylmethane 2,4′-diisocyanate and diphenylmethane 4,4′-diisocyanate and higher polycyclic homologs of diphenylmethane diisocyanate (polymer MDI), and mixtures of these isocyanates. The isocyanate used is in particular an aromatic isocyanate selected from the group consisting of diphenylmethane 2,4′-diisocyanate, diphenylmethane 4,4′-diisocyanate, higher polycyclic homologs of diphenylmethane diisocyanate or mixtures of two or more of these compounds.

The polyols (b) having at least two isocyanate-reactive groups which are used can be isocyanate-reactive compounds which are known for the preparation of polyurethanes and have a molecular weight of more than 250 g/mol. Preference is given to using polyesterols, polyetherols or polyether-polyesterols that may be obtained, for example, by alkoxylation of polyesters.

Polyether polyols (b) are prepared from one or more alkylene oxides having 2 to 4 carbon atoms in the alkylene radical by known methods, for example by anionic polymerization with alkali metal hydroxides or alkali metal alkoxides as catalysts or by cationic polymerization with Lewis acids such as antimony pentachloride or boron trifluoride etherate as catalysts, with the addition of at least one starter molecule comprising 2 to 8 reactive hydrogen atoms. Moreover, catalysts used may also be multimetal cyanide compounds, so-called DMC catalysts. Examples of suitable alkylene oxides are tetrahydrofuran, 1,3-propylene oxide, 1,2- and 2,3-butylene oxide and preferably ethylene oxide and 1,2-propylene oxide. The alkylene oxides may be used individually, alternately in succession or as mixtures. Preference is given to using 1,2-propylene oxide, ethylene oxide or mixtures of 1,2-propylene oxide and ethylene oxide.

The polyether polyols (b) here comprise 50% to 90% by weight, preferably 60% to 85% by weight and especially 65% to 80% by weight of at least one polyalkylene oxide (b1) having a hydroxyl number of from 120 to 300 mg KOH/g, preferably 150 to 250 mg KOH/g and particularly preferably 160 to 200 mg KOH/g, based on a difunctional starter molecule, and an ethylene oxide content, based on the content of alkylene oxide, of from 60% to 100% by weight, preferably 70% to 100% by weight, particularly preferably 90% to 100% by weight and especially exclusively ethylene oxide, and a proportion of primary OH groups of from 50% to 100%, preferably 90% to 100% and especially 100%. Suitable starter molecules preferably include water or di- and trihydric alcohols such as ethylene glycol, propane-1,2- or -1,3-diol, diethylene glycol, dipropylene glycol and butane-1,4-diol.

Component (b) further comprises 10% to 50% by weight, preferably 15% to 40% by weight and particularly preferably 20% to 35% by weight of at least one polyalkylene oxide (b2) having a hydroxyl number of from 120 to 600 mg KOH/g, preferably 150 to 500 mg KOH/g and particularly preferably 150 to 400 mg KOH/g, based on a difunctional and/or a trifunctional, preferably exclusively trifunctional, starter molecule, and an ethylene oxide content, based on the content of alkylene oxide, of from 0% to 40% by weight, preferably 0% to 20% by weight and especially exclusively propylene oxide. Suitable starter molecules preferably include water or di- and trihydric alcohols such as ethylene glycol, propane-1,2- or -1,3-diol, diethylene glycol, dipropylene glycol, butane-1,4-diol, glycerol, and trimethylolpropane, preferably glycerol.

In addition to the polyetherols (b1) and (b2), 0% to 30% by weight, preferably 0% to 15% by weight, particularly preferably 0% to 5% by weight of at least one further polyalkylene oxide (b3), which differs from the polyetherols (b1) and (b2), may be present, based in each case on the total weight of components (b1) to (b3). This preferably has a hydroxyl number of from 100 to 800 mg KOH/g, based on a difunctional to tetrafunctional starter molecule. In a very preferred embodiment, no polyetherol (b3) is used.

In addition to the polyetherols (b1) and (b2) and optionally (b3), further polyols which are customary in polyurethane chemistry may be used. These have a molecular weight of more than 250 g/mol and preferably of less than 10 000 g/mol, and include further polyether polyols which do not fall under the definition of polyether polyols (b1) to (b3), and also polyester polyols and other compounds comprising isocyanate-reactive groups and having a molecular weight of greater than 250 g/mol, such as OH group-containing or alkoxylated fats such as castor oil or alkoxylated castor oil or fatty acids such as ricinoleic acid or polyamines.

The proportion of polyether polyols (b1) to (b3) in the polyols (b) is preferably 70% to 100% by weight, particularly preferably 85% to 100% by weight, more preferably 90% to 100% by weight and further preferably 95% to 100%, based on the total weight of component (b). In particular, the polyols (b) used are exclusively the polyols (b1), (b2) and optionally (b3).

Suitable starter molecules preferably include water or di- and trihydric alcohols such as ethylene glycol, propane-1,2- or -1,3-diol, diethylene glycol, dipropylene glycol, butane-1,4-diol, glycerol, and trimethylolpropane.

The blowing agent (c) used is a blowing agent comprising water. In this case, water can be used alone or in combination with further blowing agents. The content of water in the blowing agent (c) is preferably greater than 40% by weight, particularly preferably greater than 60% by weight and very particularly preferably greater than 80% by weight, based on the total weight of the blowing agent (c). In particular, water is used as the sole blowing agent. Where other blowing agents are used in addition to water, it is possible for example to use chlorofluorocarbons, hydrofluorocarbons, hydrocarbons, acids and liquid or dissolved carbon dioxide. Blowing agents (c) preferably comprise less than 50% by weight, more preferably less than 20% by weight, particularly preferably less than 10% by weight and especially 0% by weight, based on the total weight of blowing agent (c), of chlorofluorocarbons, hydrofluorocarbons and/or hydrocarbons. In a further embodiment, the blowing agent (c) used may be a mixture of water and formic acid and/or carbon dioxide. In order to be able to more easily disperse the blowing agent in the polyol component, the blowing agent (c) can be mixed with polar compounds such as dipropylene glycol.

The blowing agents (c) are used in such an amount that the density of the polyurethane adhesive (C), which is formed by reaction of the components (a) to (f), including reinforcers (f) is in the range from 40 to 800 kg/m³, preferably 50 to 200 kg/m³, particularly preferably 60 to 120 kg/m³. The content of water, based on the total weight of components (b) to (e), is preferably 0.3% to 3% by weight, particularly preferably 0.8% to 2% by weight.

Chain extenders and/or crosslinking agents (d) may also optionally be used for the preparation of the adhesive (C). The addition of the chain extenders and/or crosslinking agents may take place before, together with, or after the addition of the polyols. The chain extenders and/or crosslinking agents used are substances having a molecular weight of preferably less than 250 g/mol, particularly preferably of 60 to 200 g/mol, where chain extenders have 2 isocyanate-reactive hydrogen atoms and crosslinking agents have 3 isocyanate-reactive hydrogen atoms.

These may be used individually or in the form of mixtures. Where chain extenders are used, propane-1,3- and -1,2-diol, dipropylene glycol, tripropylene glycol, and butane-1,3-diol are particularly preferred.

If chain extenders, crosslinking agents or mixtures thereof are used, these are expediently used in amounts of 1% to 30% by weight, preferably 1.5% to 20% by weight, and especially 2% to 10% by weight, based on the weight of polyisocyanates, relative to polymeric isocyanate-reactive compounds and chain extenders and/or crosslinking agents; preferably no chain extenders and/or crosslinking agents are used.

The catalysts (e) used may be any compounds which accelerate the isocyanate-water reaction or the isocyanate-polyol reaction. Such compounds are known and are described, for example, in “Kunststoffhandbuch [Plastics Handbook], volume 7, Polyurethane [Polyurethanes]”, Carl Hanser Verlag, 3rd Edition 1993, Chapter 3.4.1. These comprise amine-based catalysts and catalysts based on organic metal compounds.

Catalysts that can be used which are based on organic metal compounds are, for example, organic tin compounds such as tin(II) salts of organic carboxylic acids, such as tin(II) acetate, tin(II) octoate, tin(II) ethylhexoate and tin(II) laurate, and the dialkyltin(IV) salts of organic carboxylic acids, such as dibutyltin diacetate, dibutyltin dilaurate, dibutyltin maleate and dioctyltin diacetate, and also bismuth carboxylates such as bismuth(III) neodecanoate, bismuth 2-ethylhexanoate and bismuth octanoate or alkali metal salts of carboxylic acids, such as potassium acetate or potassium formate.

The catalyst (e) used is preferably an amine catalyst, that is to say at least one compound comprising at least one tertiary nitrogen atom. Examples include amidines such as 2,3-dimethyl-3,4,5,6-tetrahydropyrimidine, tertiary amines such as triethylamine, tributylamine, dimethylbenzylamine, N-methyl-, N-ethyl-, and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds such as triethanolamine, triisopropanolamine, N-methyl- and N-ethyldiethanolamine, and dimethylethanolamine. These tertiary amines may also be compounds which bear isocyanate-reactive groups such as OH, NH or NH₂ groups. Some of the most frequently used catalysts are bis(2-dimethylaminoethyl) ether, N,N,N,N,N-pentamethyldiethylenetriamine, N,N,N-triethylaminoethoxyethanol, dimethylcyclohexylamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl)hexahydrotriazine, dimethylaminopropylamine, N-ethylmorpholine, diazabicycloundecene and diazabicyclononene.

If a low migration of catalysts out of the adhesives (C) of the invention and/or a low emission of VOC compounds is desired, incorporable catalysts may also be used. Catalysts may also be dispensed with entirely.

Preference is given to using exclusively amine catalysts as catalysts (e). Preference is given to using 0.001% to 5% by weight, especially 0.05% to 2% by weight, of catalyst, based on the weight of component (b).

Auxiliaries (f) used may for example be flame retardants, stabilizers, thickeners, fillers and other additives, such as antioxidants. Preference is given to at least using fillers.

Flame retardants used may generally be the flame retardants known from the prior art. Suitable flame retardants are, for example, brominated ethers (Ixol B 251), brominated alcohols such as dibromoneopentyl alcohol, tribromoneopentyl alcohol and PHT-4-diol and also chlorinated phosphates, such as for example tris(2-chloroethyl) phosphate, tris(2-chloroisopropyl) phosphate (TCPP), tris(1,3-dichloroisopropyl) phosphate, tris(2,3-dibromopropyl) phosphate and tetrakis(2-chloroethyl) ethylenediphosphate, or mixtures thereof.

Apart from the halogen-substituted phosphates already mentioned, it is also possible to use inorganic flame retardants such as red phosphorus, preparations comprising red phosphorus, expandable graphite, aluminum oxide hydrate, antimony trioxide, arsenic oxide, ammonium polyphosphate and calcium sulfate or cyanuric acid derivatives such as melamine, or mixtures of at least two flame retardants, such as ammonium polyphosphates and melamine, and optionally starch, to render the rigid polyurethane foams produced according to the invention flame retardant. Further liquid, halogen-free flame retardants used may be diethyl ethanephosphonate (DEEP), triethyl phosphate (TEP), dimethyl propylphosphonate (DMPP), diphenyl cresyl phosphate (DPC) and others.

The flame retardants for the purposes of the present invention are preferably used in an amount of from 0% to 25%, based on the total weight of the components (b) to (e).

“Stabilizers” refers to substances which promote the formation of a regular cell structure during foaming. Mention may be made by way of example of: silicone-containing foam stabilizers such as siloxane-oxyalkylene copolymers and other organopolysiloxanes. Additionally, alkoxylation products of fatty alcohols, oxo alcohols, fatty amines, alkylphenols, dialkylphenols, alkylcresols, alkylresorcinol, naphthol, alkylnaphthol, naphthylamine, aniline, alkylaniline, toluidine, bisphenol A, alkylated bisphenol A, polyvinyl alcohol and also furthermore alkoxylation products of condensation products of formaldehyde and alkylphenols, formaldehyde and dialkylphenols, formaldehyde and alkylcresols, formaldehyde and alkylresorcinol, formaldehyde and aniline, formaldehyde and toluidine, formaldehyde and naphthol, formaldehyde and alkylnaphthol and also formaldehyde and bisphenol A or mixtures of two or more of these foam stabilizers.

Foam stabilizers are preferably used in an amount of from 0.5% to 4% by weight, particularly preferably 0.5% to 3% by weight, based on the total weight of the components (b) to (e).

Thickeners used are substances which rapidly increase the viscosity of the reaction mixture after the mixing of the components (a) to (f) while retaining the flowability of the reaction mixture. This is achieved by compounds having molecular weights of less than 500 g/mol and two isocyanate-reactive groups which are more reactive in the reaction with isocyanate than the isocyanate-reactive groups of the compounds from component (b). Generally, primary OH groups are more reactive than secondary OH groups and amino groups are more reactive than OH groups. Thickeners ensure that isocyanates preferentially react with the thickeners. This leads to a rapid increase in molecular weight and thus to a rapid viscosity increase but not to a crosslinking or to molecules which on account of their large molecular weight result in a curing. The thickeners preferably have a molecular weight of from 58 to 350 g/mol, particularly preferably 100 to 350 g/mol. As isocyanate-reactive groups, the thickeners preferably have two primary amino groups here, each of which may be primary or secondary and aliphatic or aromatic. In a particularly preferred embodiment, the amino groups primary amino groups are bonded to aromatic carbon atoms, preferably to an aromatic 6-membered ring. In particular, the thickeners (d) used are N,N′-bis(3-aminopropyl)ethylenediamine, 4,4′-methylenebis(2-methylcyclohexylamine), 4,4′-methylenebis(2,6-diethylaniline), 3-aminomethyl-3,5,5-trimethylcyclohexylamine, 3,5-dimethylthio-2,4-toluenediamine and polyetheramines.

Fillers, in particular reinforcing fillers, are understood to mean the customary organic and inorganic fillers known per se. Specific examples are: inorganic fillers such as siliceous minerals, for example phyllosilicates such as antigorite, serpentine, hornblendes, amphiboles, chrysotile, talc; metal oxides such as kaolin, aluminum oxides, titanium oxides and iron oxides, metal salts such as chalk, barite and inorganic pigments such as cadmium sulfide, zinc sulfide and also glass and others. It is preferable to use kaolin (china clay), aluminum silicate and coprecipitates of barium sulfate and aluminum silicate, and also natural and synthetic fibrous minerals, for example wollastonite, and fibers of various lengths made of metal and in particular of glass; these can optionally have been sized. Examples of useful organic fillers include: carbon, melamine, rosin, cyclopentadienyl resins and graft polymers, and also cellulose fibers, polyamide fibers, polyacrylonitrile fibers, polyurethane fibers and polyester fibers derived from aromatic and/or aliphatic dicarboxylic esters, and in particular carbon fibers.

The inorganic and organic fillers may be used individually or as mixtures and are advantageously incorporated into the reaction mixture in amounts of from 0% to 80% by weight, particularly preferably 20% to 75% by weight, and especially 40% to 70% by weight, based on the weight of components (b) to (e).

The calorific value of the adhesive (C), with 60% by weight of organic fillers, according to DIN EN ISO 1716 is preferably at most 20 MJ/kg, particularly preferably at most 18 MJ/kg and especially at most 15 MJ/kg. Furthermore, the calorific value of the adhesive (C) without the use of fillers according to DIN EN ISO 1716 is at most 30 MJ/kg, particularly preferably at most 28 MJ/kg and especially at most 26 MJ/kg.

As outer layer (A), use may be made of gypsum plasterboard, glass tiles, aluminum foils, aluminum sheets, copper sheets or steel sheets, preferably aluminum foils, aluminum sheets or steel sheets, particularly preferably steel sheets. The steel sheets may be coated, for example with customary anti-corrosion coatings, or uncoated. They are preferably not corona-treated.

In conventional sandwich elements, the thermal insulation material is enclosed by a lower and an upper outer layer. Both outer layers must be bonded to the thermal insulation material for the production. In addition, the thermal insulation material (B) may be composed of a plurality of layers which are bonded with the adhesive (C) of the invention. For bonding of the individual layers of the thermal insulation material and/or bonding of the thermal insulation material to the outer layer, for example the upper outer layer, the adhesive (C) may be applied to the outer layer or to the thermal insulation material.

Examples of the thermal insulation material (B) used for the process of the invention are organic thermal insulation materials, such as commercially available panels of foamed plastics, such as foamed polystyrene (EPS, XPS), foamed PVC, foamed polyurethane or melamine resin foams, or preferably inorganic, thermal insulation materials such as conventional mineral insulation materials. Such mineral insulation materials preferably comprise thermal insulation material made from mineral wool and/or stone wool, for example as a nonwoven or in panel form. The thermal insulation material (B) used is in particular panels of mineral wool, such as glass wool, or stone wool.

In one embodiment of the present invention, the adhesive (C) of the invention is used for bonding in the production of aerogel insulation systems. These comprise layers of aerogel-containing materials, for example aerogel composites, and/or aerogels, and also non-aerogel-containing insulation materials and/or non-insulating materials, such as outer layers (A).

Aerogels are a class of porous materials having open cells which comprise a framework of interconnected structures, having a corresponding network of pores which are integrated into the framework, and having an interstitial phase within the network of pores which primarily consists of gases, such as for example air. Aerogels are typically characterized by a low density, a high porosity, a large surface area and small pore sizes. Low-density aerogel materials are widely considered to be the best available solid insulating materials. Aerogels function as insulating materials primarily by minimizing conduction (low structural density leads to a tortuous path for the transfer of energy through the solid framework), convection (large pore volumes and very small pore sizes lead to minimal convection), and radiation (IR absorbing or scattering dopants are easily dispersed over the entire aerogel matrix). Aerogels can be used in a wide range of applications including the following: insulation for heating and cooling, sound insulation, electronic dielectrics, aviation, energy storage and generation, and filtration. Aerogel materials furthermore exhibit many other interesting acoustic, optical, mechanical and chemical properties which make them immensely useful for various insulation and non-insulation applications.

Aerogels can be distinguished from other porous materials by their physical and structural properties. Within the context of the present disclosure, the term “aerogel” or “aerogel material” refers to a gel comprising a framework of interconnected structures (network of interconnected oligomers, polymers or colloidal particles which form the solid structure of a gel or of an aerogel) with a corresponding network of interconnected pores which are integrated into the basic structure and contain gases, such as for example air, as dispersed interstitial medium; and which is characterized by the following physical and structural properties (according to nitrogen porosimetry tests) which are ascribable to aerogels: (a) an average pore diameter in the range from approximately 2 nm to approximately 100 nm, (b) a porosity of at least 80% or more and (c) a surface area of approximately 20 m²/g or more. Aerogel materials of the present disclosure consequently encompass all aerogels or other open-cell compositions which satisfy the defining elements set forth in the preceding paragraphs, which includes compositions which may otherwise be categorized as xerogels, cryogels, ambigels, microporous materials and the like. Aerogel materials can furthermore also be characterized by additional physical properties including the following: (d) a pore volume of approximately 2.0 ml/g or more, preferably approximately 3.0 ml/g or more; (e) a density of approximately 0.50 g/cm³ or less, preferably approximately 0.25 g/cm³ or less; and where (f) at least 50% of the entire pore volume comprises pores having a pore diameter of between 2 and 50 nm; although satisfying theses additional properties is not necessary for characterization of a composition as an aerogel material.

Aerogel materials may be formed as an essentially one-piece sheet or as blocks of material having an essentially continuous and interconnected structural framework and a pore network. Aerogel materials may also be formed as particulate aerogel materials, including aerogel material in the form of particles, particulates, granules, beads or powders which can be combined or compressed together but which lack an interconnected structural aerogel framework and a pore network between individual particles.

Aerogel material can be incorporated into various composite materials, including the following: fiber-reinforced aerogel composites; aerogel composites comprising added elements, for example opacifiers; composite materials in which aerogel particles, particulates, granules, beads or powders have been incorporated into a solid or semisolid material, such as for example binders, resins, cements, foams, polymers or similar solid materials.

Aerogel materials can be fiber-reinforced with various fiber reinforcement materials, in order to obtain a more flexible, more robust, and more conformable composite product. The fiber reinforcement materials may be added to the gels at any point in the gel-forming process, in order to produce a wet, fibrous gel composition. The wet gel composition can then be dried to produce a fiber-reinforced aerogel composite product. Fiber reinforcement materials can take the form of discrete fibers, wovens, nonwovens, batting, webs, mats and felts. Fiber reinforcements may be manufactured from organic fiber materials, inorganic fiber materials or combinations of these.

In a preferred embodiment, nonwoven fiber reinforcement materials are incorporated into the aerogel materials as a continuous sheet of interconnected or interlaced fiber reinforcement materials. The process initially comprises producing a continuous sheet of fiber-reinforced gel by pouring or impregnating a gel precursor solution into a continuous sheet of interconnected or interlaced fiber reinforcement materials. The liquid phase can then be at least partially extracted from the fiber-reinforced gel sheets in order to produce a sheetlike, fiber-reinforced aerogel composite product.

An aerogel material may also comprise an opacifier in order to reduce the radiated component of heat transfer. Opacifying compounds or their precursors may be dispersed in the mixture comprising gel precursors at any point prior to the gel formation. Examples of opacifying compounds include, but are not limited to, the following: boron carbide [B₄C], diatomite, manganese ferrite, MnO, NiO, SnO, Ag₂O, Bi₂O₃, carbon black, titanium oxide, iron titanium oxide, aluminum oxide, zirconium silicate, zirconium oxide, iron(II) oxide, iron(Ill) oxide, manganese dioxide, iron titanium oxide (ilmenite), chromium oxide, carbides (such as SiC, TiC or WC) or mixtures thereof. Examples of precursors to opacifying compounds include, but are not limited to, the following: TiOSO₄ or TiOCI₂.

Aerogel materials and aerogel composites of the presented disclosure generally have excellent thermal insulation properties, which includes very low thermal conductivity properties. Within the context of the present disclosure, the terms “thermal conductivity” and “TC” refer to a measurement of the capacity of a material or of a composition to transfer heat between two surfaces on either side of the material or of the composition in the presence of a temperature difference between the two surfaces. Thermal conductivity is measured in particular as the thermal energy transferred per unit of time and per unit of surface area, divided by the temperature difference. It is typically measured in SI units as mW/m*K (milliwatts per meter*kelvin). In the context of the present disclosure, thermal conductivity measurements are recorded according to ASTM C177 standards at a temperature of approximately 37.5° C. at atmospheric pressure and with a compression of approximately 2 psi, unless stated otherwise. Aerogel materials or composites of the present disclosure preferably have a thermal conductivity of approximately 30 mW/m*K or less, approximately 25 mW/m*K or less, approximately 20 mW/m*K or less, approximately 18 mW/m*K or less, approximately 16 mW/m*K or less, approximately 14 mW/m*K or less, approximately 12 mW/m*K or less, or in a range between any two of these values.

Aerogel materials or aerogel composites of the presented disclosure generally have very low densities. In the context of the present disclosure, the term “density” refers to a measurement of the mass per unit volume. The term “density” generally relates to the true density of an aerogel material, and also to the packing density of the aerogel material. The density of an aerogel material or of the aerogel composite can be determined according to the ASTM C167 standards, unless stated otherwise. Aerogel materials or aerogel composites of the present disclosure preferably have a density of approximately 0.60 g/cm³ or less, approximately 0.40 g/cm³ or less, approximately 0.30 g/cm³ or less, approximately 0.20 g/cm³ or less, approximately 0.15 g/cm³ or less, approximately 0.12 g/cm³ or less, approximately 0.10 g/cm³ or less, approximately 0.05 g/cm³ or less, approximately 0.01 g/cm³ or less, or in a range between any two of these values.

Aerogel materials or aerogel composites may be hydrophilic (high water absorption). However, aerogel materials of the presented disclosure may have been modified so that they have an improved hydrophobicity (low water absorption). In the context of the present disclosure, the term “hydrophobicity” refers to a measurement of the capacity of an aerogel material or of the aerogel composite to repel water. In the context of the present disclosure, the term “hydrophobicity” refers to a measurement of the capacity of an aerogel material or of an aerogel composite to repel water. The hydrophobicity of an aerogel material or of the aerogel composite can be expressed in terms of the uptake of liquid water, which is the potential of an aerogel material or an aerogel composite to absorb or otherwise retain liquid water. The uptake of liquid water can be expressed as a percentage (based on the mass or the volume) of the water absorbed or otherwise retained by an aerogel material or aerogel composite when it is exposed to liquid water under particular measurement conditions. In the context of the present disclosure, measurements of the uptake of liquid water are recorded in accordance with the ASTM C1763 standards, unless stated otherwise. Aerogel materials or aerogel composites of the present disclosure may exhibit an uptake of liquid water according to ASTM C1763 of approximately 30% by mass or less, approximately 20% by mass or less, approximately 15% by mass or less, approximately 10% by mass or less, approximately 8% by mass or less, approximately 3% by mass or less, approximately 2% by mass or less, approximately 1% by mass or less, approximately 0.1% by mass or less, or in a range between any two of these values. The hydrophobicity of an aerogel material or aerogel composite can be expressed in terms of the uptake of water vapor, which relates to a measurement of the potential of an aerogel material or aerogel composite to absorb water vapor. The uptake of water vapor can be expressed as a percentage (based on the mass) of the water absorbed or otherwise retained by an aerogel material or an aerogel composite when it is exposed to water vapor under particular measurement conditions. In the context of the present disclosure, measurements of the uptake of water vapor are recorded in accordance with the ASTM C1104 standards, unless stated otherwise. Aerogel materials or aerogel composites of the present disclosure may preferably exhibit an uptake of water vapor of approximately 30% by mass or less, approximately 20% by mass or less, approximately 15% by mass or less, approximately 10% by mass or less, approximately 8% by mass or less, approximately 3% by mass or less, approximately 2% by mass or less, approximately 1% by mass or less, approximately 0.1% by mass or less, or in a range between any two of these values. The hydrophobicity of an aerogel material or of the aerogel composite can be expressed by measuring the equilibrium contact angle of a water droplet at the interface with the surface of the material. Aerogel materials or aerogel composites of the present disclosure may exhibit a water contact angle of approximately 130° or more, approximately 140° or more, approximately 150° or more, approximately 160° or more, approximately 170° or more, approximately 175° or more, or in a range between any two of these values.

In the context of the present disclosure, the terms “heat of combustion” and “HoC” refer to a measurement of the amount of thermal energy released on combustion of an aerogel material or of an aerogel composite. The heat of combustion is typically measured in calories of thermal energy released per gram of the aerogel material (cal/g) or as megajoules of thermal energy released per kilogram of the aerogel material or aerogel composite (MJ/kg). In the context of the present disclosure, measurements of the heat of combustion are recorded under conditions comparable to ISO 1716 standards, unless stated otherwise. Aerogel materials or aerogel composites of the present disclosure may preferably exhibit a heat of combustion or approximately 717 cal/g or less, approximately 700 cal/g or less, approximately 650 cal/g or less, approximately 600 cal/g or less, approximately 575 cal/g or less, approximately 550 cal/g or less, approximately 500 cal/g or less, approximately 450 cal/g or less, approximately 400 cal/g or less, approximately 350 cal/g or less, approximately 300 cal/g or less, approximately 250 cal/g or less, approximately 200 cal/g or less, approximately 150 cal/g or less, approximately 100 cal/g or less, approximately 50 cal/g or less, approximately 25 cal/g or less, approximately 10 cal/g or less, or in a range between any two of these values.

Aerogels are described as a framework of interconnected structures which typically comprise interconnected oligomers, polymers or colloidal particles. An aerogel framework can be made from a range of precursor materials, including the following: inorganic precursor materials (such as for example precursors used when producing silicon dioxide-based aerogels); organic precursor materials (such as for example precursors used when producing carbon-based aerogels); hybrid inorganic/organic precursor materials; and combinations of these. In the context of the present disclosure, the term “amalgam aerogel” refers to an aerogel which has been produced from a combination of at least two different gel precursors.

Inorganic aerogels are generally formed from metal oxide or metal alkoxide materials. The metal oxide or metal alkoxide materials may be based on oxides or alkoxides of any metals which can form oxides. Such metals include, but are not limited to: silicon, aluminum, titanium, zirconium, hafnium, yttrium, vanadium, cerium and the like. Inorganic silicon dioxide aerogels are conventionally produced via the hydrolysis and condensation of silicon dioxide-based alkoxides (such as for example tetraethoxylsilane) or via gel formation from silica or waterglass. Other relevant inorganic precursor materials for a silicon dioxide-based aerogel synthesis include, but are not limited to: metal silicates, such as for example sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethyl silicates, partially hydrolyzed polyethyl silicates, monomeric alkylalkoxysilanes, bistrialkoxyalkyl- or -arylsilanes, polyhedral silsesquioxanes or combinations of these. In certain embodiments of the present disclosure, prehydrolyzed TEOS, such as Silbond H-5 (SBH5, Silbond Corp), which is hydrolyzed at a water/silicon dioxide ratio of approximately 1.9-2, may be used in the form available commercially or may be further hydrolyzed prior to incorporation into the gelling process. Partially hydrolyzed TEOS or TMOS, such as polyethyl silicate (Silbond 40) or polymethyl silicate, may also be used in the form available commercially or may be further hydrolyzed prior to incorporation into the gelling process.

Inorganic aerogels may also comprise gel precursors comprising at least one hydrophobic group, such as for example alkyl metal alkoxides, cycloalkyl metal alkoxides and aryl metal alkoxides, which can impart particular properties on the gel or improve these properties, such as for example stability and hydrophobicity. Inorganic silicon dioxide aerogels may specifically comprise hydrophobic precursors such as alkylsilanes or arylsilanes. Hydrophobic gel precursors may be used as primary precursor materials in order to form the framework of a gel material. However, hydrophobic gel precursors are usually used as co-precursors in combination with simple metal alkoxides in the formation of amalgam aerogels. Hydrophobic inorganic precursor materials for a silicon dioxide-based aerogel synthesis include, but are not limited to, the following: trimethylmethoxysilane [TMS], dimethyldimethoxysilane [DMS], methyltrimethoxysilane [MTMS], trimethylethoxysilane, dimethyldiethoxysilane [DMDS], methyltriethoxysilane [MTES], ethyltriethoxysilane [ETES], diethyldiethoxysilane, ethyltriethoxysilane, propyltrimethoxysilane, propyltriethoxysilane, phenyltrimethoxysilane, phenyltriethoxysilane [PhTES], hexamethyldisilazane and hexaethyldisilazane and the like.

Aerogel materials of the present disclosure are preferably inorganic silicon dioxide aerogels formed primarily from alcohol solutions of hydrolyzed silicate esters formed from silicon alkoxides.

Organic aerogels are generally formed from carbon-based polymer precursors. Such polymer materials comprise, but are not limited to, the following: resorcinol-formaldehydes (RF), polyimide, polyacrylate, polymethyl methacrylate, acrylate oligomers, polyoxyalkylene, polyurethane, polyphenol, polybutadiene, trialkoxysilyl-terminated polydimethylsiloxane, polystyrene, polyacrylonitrile, polyfurfural, melamine-formaldehyde, cresol-formaldehyde, phenol-furfural, polyethers, polyol, polyisocyanate, polyhydroxybenzene, polyvinyl alcohol dialdehyde, polycyanurates, polyacrylamides, various epoxides, agar, agarose, alginates, chitosan and combinations of these. For example, organic RF aerogels are typically produced from the sol-gel polymerization of resorcinol or melamine with formaldehyde under alkaline conditions.

Prior to the bonding, the components of the polyurethane adhesive (C) are mixed, for example using mixing equipment known in polyurethane chemistry, such as high-pressure or low-pressure mixers. It is possible in this case to use a two-component process. For this, the components are typically mixed in a ratio such that the isocyanate index is in a range from 80 to 400, preferably 90-200, particularly preferably 100-140.

In the context of the present invention, the isocyanate index is understood here to mean the stoichiometric ratio of isocyanate groups to isocyanate-reactive groups, multiplied by 100. “Isocyanate-reactive groups” are understood here to mean all isocyanate-reactive groups present in the reaction mixture, including chemical blowing agents but not the isocyanate group itself.

In the context of the present invention, the bonding of the thermal insulation materials is to be understood here to mean the bonding of thermal insulation materials of the same kind to each other and the bonding of thermal insulation materials (B) to other materials, for example to thermal insulation materials of a different kind or to other materials, for example an outer layer (A). The bonding of the outer layer (A) to the thermal insulation material (B) or of the thermal insulation materials to each other is not restricted and can be effected both in a discontinuous or continuous process. Such processes are known.

In a particularly preferred embodiment, the outer layer (A) is bonded to the thermal insulation material (B). For the bonding of the outer layer (A) to the thermal insulation material (B), the adhesive (C) may be applied to the outer layer (A) or to the thermal insulation material (B). The adhesive (C) is preferably applied to the outer layer (A). The adhesive may be applied by any known application method, for example by knife coating, spraying or by application apparatuses such as a rotating, flat body. Such an application method using a rotating, flat body has been described for example in EP 1896259. This is usually effected in amounts of from 30 to 300 g/m², preferably 40 to 200 g/m² and especially 50 to 150 g/m².

In a further embodiment of the present invention, layers of the thermal insulation material (B) are bonded to each other. The insulation material layers (B) used in the bonding of the insulation layers are preferably aerogel materials or aerogel composite materials.

Aerogel composites have previously already been bonded to the other materials using various resins or adhesives. Examples of resins or adhesives which have previously been used include the following: epoxides; cyanoacrylates; phenolic thermosets; polyether ether ketones: caprolactams; cement-based adhesives; silicates, such as for example sodium silicates and potassium silicates; latexes; silicones; polystyrenes; polyimides; polyureasilazanes; polybutadienes; urethanes; acrylate adhesives; and rubber resin adhesives.

However, none of the previously used adhesives enables the production of multi-layer aerogel composite insulation systems which exhibit the combination of physical properties in the novel materials of the present disclosure. Using adhesive (C) of the invention produces multi-layer aerogel composite insulation systems having a novel combination of thermal conductivity, heat of combustion and transverse tensile strength. In one preferred embodiment of the present invention, the multi-layer aerogel composite insulation system exhibits the following properties: 1) a thermal conductivity of between 12 and 25 mW/m*K, preferably between 14 and 22 mW/m*K and particularly preferably between 14 and 20 mW/m*K; 2) a heat of combustion of 750 cal/g or less, preferably 717 cal/g or less, particularly preferably 700 cal/g or less and particularly preferably 650 cal/g or less; and 3) a transverse tensile strength of 5 kPa or more, preferably 7.5 kPa or more, particularly preferably 10 kPa or more, particularly preferably 12.5 kPa of more and particularly preferably 15 kPa or more.

Adhesives (C) of the invention can be applied to the surface of an aerogel composite layer using direct application methods such as for example using a spatula, a brush, a roller, a doctor blade or comparable direct-application tools and techniques. Alternatively, application can be achieved using spray or aerosolizing equipment, such as for example using continuous spraying methods which use a multicomponent spraying device designed to pump, mix and atomize adhesives. As an alternative, a rotating application apparatus as described above may be used.

In one embodiment of the present invention, a multi-layer insulation system is produced by applying the adhesive (C) of the present disclosure to the surface of at least one layer comprising an aerogel composite and subsequently bonding the aerogel composite layer to a second material layer.

In a further embodiment of the present disclosure, a multi-layer insulation system is produced by applying the adhesive (C) to one or more surfaces of at least two aerogel composite layers and subsequently bonding the at least two aerogel composite layers in order to form a multi-layer aerogel composite panel. The multi-layer aerogel composite panel may be further adhered to additional layers or surfaces, such as an outer layer (A), using additional amounts of the polyurethane adhesive of the present disclosure.

In a preferred embodiment of the present disclosure, a multi-layer insulation system is produced by applying a polyurethane adhesive to the surfaces of two or more layers comprising aerogel composites, and subsequently bonding the at least two aerogel composite layers in order to form a multi-layer aerogel composite panel. The adhesives, which are employed to produce panels from aerogel composite layers, that are used here are polyurethane adhesives (C). The multi-layer aerogel composite panels preferably have high transverse tensile strengths. In the context of the present disclosure, the term “transverse tensile strength” refers to a measurement of the tensile strength of a material perpendicularly to the visible face of the material. The transverse tensile strength is typically given in kPa and can be determined according to EN 1607 standards, unless stated otherwise. Multi-layer insulation systems or panels of the present disclosure preferably have a transverse tensile strength of more than 3 kPa, more than 5 kPa, more than 7.5 kPa, more than 10 kPa, more than 12.5 kPa, more than 15 kPa, or in a range between any two of these values.

Composite elements of the invention have a very high adhesion, for example between thermal insulation material (B) and outer layer (A) or between the layers of the thermal insulation material (B) bonded to each other. These furthermore have a very high fire resistance. Finally, even a small amount of adhesive (C) is sufficient for a bond having good strength, as a result of which the fire resistance of the composite element is further improved compared to composite elements from the prior art.

The invention is illustrated hereinafter on the basis of examples:

The following feedstocks were used:
Polyol 1: polypropylene oxide triol, OH number 400 mg KOH/g
Polyol 2: polypropylene oxide diol, OH number 190 mg KOH/g
Polyol 3: polypropylene oxide triol, OH number 160 mg KOH/g
Polyol 4: aromatic polyesterol from Stepan, having an OH number of 315 mg KOH/g and an OH functionality of 2.0 (PS-3152)
Polyol 5: polyethylene oxide diol, OH number 190 mg KOH/g
Amine catalyst: triethylenediamine, 33% in dipropylene glycol
Filler: combination of calcium carbonate particles and silica particles from Omya and
Evonik Industr., weight ratio 98.8% calcium carbonate to 1.2% silica
Stab.: silicone stabilizer
Disp.: dispersant combination of calcium carbonate particles and silica particles from Omya and Evonik Industries, weight ratio 98.8% calcium carbonate to 1.2% silica
Isocyanate: mixture of MDI and higher polycyclic homologs of MDI having a viscosity at 25° C. of approx. 200 mPas at 25° C.

Adhesives were prepared according to table 1 and their curing behavior was analyzed and determined using a beaker test at room temperature. For this, the polyol component was prepared in accordance with the table and mixed with the isocyanate at an isocyanate index of 110. The viscosity was determined directly after mixing components (b)-(f).

To determine the tensile strengths and moduli of elasticity, mineral wool cubes having dimensions of 100×100×95 mm were bonded on opposite sides to metal outer layers made from steel and having dimensions of 100×100×0.7 mm in an electrically heated cubic mold (100×100×95.5 mm), to give a sandwich cube. To this end, the formulation is applied to the surfaces of the two metal sheets using a doctor blade directly after homogenization and the application rate is determined by weighing. The first metal sheet is immediately placed into the mold, which is heated to 40° C., with the wetted side facing upwards. Subsequently, the mineral wool and thereafter the second metal sheet with the wetted surface facing downwards are placed into the mold, and the mold is closed. After 5 minutes, from the start of mixing the A and B component, the sandwich cube is demolded. Two sandwich cubes are produced per test series.

After 24 hours, the cubes are sawn apart at a distance of 2 cm parallel to the metal outer layers, so that two test specimens each having dimensions of 100×100×20 mm are obtained per cube. In each case 4 test specimens were thus tested per test series; the values reported in the table are average values of the four measurements.

The tensile tests perpendicular to the outer layer are performed using a Z 1474 universal testing machine from Zwick GmbH & Co. in accordance with EN 1607, by applying a preliminary force of 50 N to the test specimen and subsequently determining the force at a testing speed of 1 mm/min until breakage occurs. The test specimens are bonded using an excess of a compact two-component polyurethane adhesive to the mounts (crossheads) which are mounted in the testing machine, and cured for a minimum of 12 hours at room temperature.

The individual appearances of the breaks were assessed visually. This is done according to the classification in table 2. Table 1 reports the average values of the individual visual assessments. Unless stated otherwise, the figures are based on parts by weight.

TABLE 1

| | Comp. 1 | Comp. 2 | Comp. 3 | Comp. 4 | Comp. 5 | Comp. 6 | Example 1 | Example 2 |
|---|---|---|---|---|---|---|---|---|
| Castor oil | 24.5 | 62 | | | | | | |
| Polyol 1 | 13.4 | 34 | 13.15 | 34 | | | 13.4 | 34 |
| Polyol 2 | | | 24.1 | 62 | | | | |
| Polyol 3 | | | | | 16.25 | 42 | | |
| Polyol 4 | | | | | 21 | 54 | | |
| Polyol 5 | | | | | | | 24.5 | 62 |
| Amine | 1.3 | 2.5 | 0.95 | 1.05 | 0.55 | 1.05 | 0.4 | 0.55 |
| catalyst | | | | | | | | |
| Stab. | 1.0 | 1.0 | 1.0 | 1.0 | 1.0 | 1.0 | 1.0 | 1.0 |
| Water | 0.93 | 1.75 | 1.0 | 0.95 | 1.2 | 2.1 | 1.0 | 2.0 |
| Filler | 60.75 | | 60.75 | | 60.75 | | 60.75 | |
| Disp. | 1.0 | | 1.0 | | 1.0 | | 1.0 | |
| Isocyanate 1 | 42.6 | 97.7 | 43.4 | 95.5 | 46.1 | 101.3 | 44.2 | 100.9 |
| Index | 110 | 110 | 110 | 110 | 110 | 110 | 110 | 110 |
| Viscosity | 7056 | 698 | 5869 | 215 | 42 760 | 246 | 9366 | 199 |
| [mPas] at | | | | | | | | |
| 20° C. | | | | | | | | |
| Start time [s] | 16 | 20 | 15 | 16 | 22 | 28 | 15 | 23 |
| Gel time [s] | 62 | 62 | 63 | 65 | 62 | 60 | 55 | 62 |
| Density [g/l] | 79.2 | 59.2 | 78.3 | 57.5 | 80.6 | 62.3 | 83.4 | 56.2 |
| Application | 180 | 126 | 159 | 137 | 189 | 126 | 131 | 116 |
| rate [g/m²] | | | | | | | | |
| Tensile | 0.06 | 0.15 | 0.11 | 0.19 | 0.18 | 0.18 | 0.24 | 0.18 |
| strength | | | | | | | | |
| [N/mm²] | | | | | | | | |
| Modulus of | 4.9 | 6.28 | 6.4 | 7.63 | 8.6 | 6.28 | 8.1 | 6.80 |
| elasticity | | | | | | | | |
| [N/mm²] | | | | | | | | |
| Calorific | 17.740 | 31.592 | 16.324 | 29.141 | 15.670 | 27.875 | 15.278 | 25.336 |
| value | | | | | | | | |
| [MJ/kg] | | | | | | | | |
| Visual | 4.0 | 2.0 | 3.4 | 3.5 | 2.9 | 2.5 | 2.6 | 2.5 |
| assessment | | | | | | | | |

TABLE 2

| Assessment | Commentary |
|---|---|
| 1.0-1.9 | Extensive layer of the fixing adhesive/ |
| | mineral wool completely intact |
| 2.0-2.9 | Residues of the fixing adhesive/ |
| | mineral wool almost completely intact |
| 3.0-3.9 | Extensive, thick mineral wool layer |
| 4.0-4.9 | Thin mineral wool layer through which |
| | the metal outer layer can be recognized |
| 5.0-5.9 | Small areas of the metal outer |
| | layer withou tmineral wool adhesion |
| 6.0 | Large areas of the metal outer |
| | layer without mineral wool adhesion |

It is clearly apparent from the values reported that the polyol combination used makes it possible to reduce the application rate of adhesive compared to known polyol combinations and at the same time the adhesion is even further improved, which is manifested by good tensile strengths and an excellent visual assessment of the appearances of the breaks. The polyurethane adhesive of the invention further exhibits an acceptable viscosity and excellent fire behavior.

### Example 3

Multi-layer laminates are produced using the adhesive from example 1. For this, a plurality of coupons of Spaceloft A2 aerogel composite (a low-combustibility aerogel insulation having a nominal thickness of 10 mm, from Aspen Aerogels, Inc.) are provided. The adhesive of example 1 is then applied at a load of 100 g/m² to the upper surface of a discrete Spaceloft A2 coupon using direct application methods (spatula, brush, roller, doctor blade, etc.). Alternatively, however, application of a two-component PU adhesive can also be achieved using continuous spraying methods which use a multicomponent spraying device designed to pump, mix and atomize adhesives having a solids content of 100%. Discrete Spaceloft A2 coupons which have been coated with the two-component mixture via direct methods or spraying methods are then assembled to give a multi-layer panel, compressed under a load of at most 2.5 psi and left to cure at room temperature for a period of not longer than 60 minutes.

A 20 mm Spaceloft A2 panel produced in such a manner exhibits a transverse tensile strength of 12 kPa, exhibits primarily substrate breakage and no breakage of the adhesive layer. Panels which have been produced with a nominal adhesive weight of 100 g/m² display an increase in thermal conductivity of not more than 10% in relation to the basic aerogel insulation blanket and have a thermal conductivity of between 12 and 25 mW/m*K, particularly preferably between 14 and 20 mW/m*K.

### Comparison 7

Multi-layer laminates of Spaceloft A2, a non-combustible aerogel-based insulation blanket, were produced using inorganic adhesives. Specifically, a series of 10 mm-thick insulation specimens measuring 20×20 mm were bonded by application of a dilute potassium silicate (Kasil 1) adhesive to each interface between the plies, in order to form a 20 to 50-mm thick one-piece insulation laminate. Silicate-based adhesives were applied to the surface of a composite aerogel using a standard HVLP spraying or direct application method. In order to improve the bond strength of the final panel, the assembled panel with a wet adhesive was cured while under uniaxial compression with a load no greater than 2.5 psi. In order to influence the curing of the aqueous silicate adhesive, a multi-layer unit of composite aerogel and wet adhesive was left to dry for a minimum of 12 hours in a convection oven at 120° C. under pressure. Alternatively, curing and drying of the silicate adhesive can be performed within a period of 20 minutes using dielectric heating.

The transverse tensile strength of Spaceloft A2 panels produced in such a manner is shown hereinafter as a function of the nominal dry adhesive mass. Multi-layer panels unfortunately exhibit values for transverse tensile strength in accordance with EN 1607 that are markedly below those recommended in ETAG 004 for use in external insulated façade systems (EIFS).

TABLE 3
Transverse tensile strength of a multi-layer
laminate of Spaceloft A2 which has been
bonded using potassium silicate.

| Potassium | Transverse tensile |
|---|---|
| silicate (g/m²) | strength (kPa) |
| 25 | 1.8 |
| 50 | 3.1 |
| 75 | 2.5 |
| 100 | 2.8 |
| 150 | 3.5 |
| 200 | 4.3 |

The thermal conductivity of the resulting 20 mm panels of Spaceloft A2 produced using potassium silicate at a dry load of 25 to 200 g/m² was measured. The resulting thermal conductivity values for the multi-layer laminates rose by not more than 10% in relation to those observed for the basic insulation blanket. The values for the heat of combustion of a 20 mm bonded panel of Spaceloft A2 produced using a nominal dry adhesive mass of 50 g/m² were also determined by the methods described in ISO 1716. Panels which were produced in such a manner exhibited an average value for the heat of combustion of 2.2 MJ/kg (for the composite as a whole), a value which is at or below that measured for the basic insulation blanket.

1. A process for producing composite elements comprising thermal insulation material (B) and adhesive (C) and optionally at least one outer layer (A), wherein the thermal insulation material (B) is bonded with the adhesive (C), wherein the adhesive (C) is a polyurethane adhesive preparable by mixing
(a) polyisocyanates with
(b) polyols having at least two isocyanate-reactive groups,
(c) blowing agents comprising water, and optionally
(d) chain extenders,
(e) catalysts and
(f) other auxiliaries,
wherein the polyols (b) comprise polyetherols and the polyetherols comprise
(b1) 50% to 90% by weight of at least one polyalkylene oxide having a hydroxyl number of from 120 to 300 mg KOH/g, based on a difunctional starter molecule, and an ethylene oxide content, based on a content of alkylene oxide, of from 60% to 100% by weight, and a proportion of primary OH groups of from 50% to 100%,
(b2) 10% to 50% by weight of at least one polyalkylene oxide having a hydroxyl number of from 120 to 600 mg KOH/g, based on a difunctional and/or a trifunctional starter molecule, and an ethylene oxide content, based on a content of alkylene oxide, of from 0% to 40% by weight and
(b3) 0% to 30% by weight of at least one further polyalkylene oxide having a hydroxyl number of from 100 to 800 mg KOH/g, based on a difunctional to tetrafunctional starter molecule, which differs from the polyetherols (b1) and (b2),
based in each case on a total weight of components (b1) to (b3), wherein a proportion of the components (b1) to (b3) is 70% to 100% by weight, based on a total weight of the component (b).

2. The process according to claim 1, wherein a proportion of the components (b1) to (b3) is 95% to 100% by weight, based on a total weight of the component (b).

3. The process according to claim 1, wherein component (b2) is obtainable exclusively proceeding from trifunctional starter molecules.

4. The process according to claim 1, wherein the ethylene oxide content of the polyetherol (b1), based on the content of alkylene oxide in the polyetherol (b1), is 100% by weight.

5. The process according to claim 1, wherein a propylene oxide content of polyetherol (b2), based on the content of alkylene oxide in polyetherol (b2), is 100% by weight.

6. The process according to claim 1, wherein no polyether polyol (b3) is used.

7. The process according to claim 1, wherein the blowing agent used is exclusively water and a content of water, based on a total weight of the components (b) to (e), is 0.3% to 3% by weight.

8. The process according to claim 1, wherein the catalyst (e) used is a tertiary amine catalyst.

9. The process according to claim 1, wherein the auxiliaries (f) comprise a thickener having two amino groups, each of which may be primary or secondary, and have a molecular weight of less than 500 g/mol.

10. The process according to claim 9, wherein the amino groups are primary amino groups, the amino groups being bonded to aromatic carbon atoms.

11. The process according to claim 1, wherein the adhesive (C) comprises 30% to 70% by weight of inorganic fillers, based on a total weight of the adhesive (C).

12. The process according to claim 1, wherein the thermal insulation material (B) is mineral wool and/or rock wool.

13. The process according to claim 1, wherein the thermal insulation material (B) comprises aerogel materials or aerogel composites.

14. The process according to claim 13, wherein the aerogel materials are bonded to one another.

15. The process according to claim 1, wherein the polyisocyanate (a) comprises isocyanates selected from the group consisting of 2,4′-MDI, 4,4′-MDI, higher polycyclic homologs of MDI and mixtures of two or more of these components.

16. The process according to claim 1, wherein the outer layer (A) and the thermal insulation material (B) are bonded with the adhesive (C).

17. A composite element comprising thermal insulation material (B) and adhesive (C) and optionally at least one outer layer (A), obtainable by the process according to claim 1.

18. A method of using an adhesive (C), preparable by mixing
(a) polyisocyanates with
(b) polyols having at least two isocyanate-reactive groups,
(c) blowing agents comprising water and optionally
(d) chain extenders,
(e) catalysts and
(f) other auxiliaries,
wherein the polyols (b) comprise polyetherols and the polyetherols comprise
(b1) 50% to 90% by weight of at least one polyalkylene oxide having a hydroxyl number of from 120 to 300 mg KOH/g, based on a difunctional starter molecule, and an ethylene oxide content, based on a content of alkylene oxide, of from 60% to 100% by weight, and a proportion of primary OH groups of from 50% to 100%,
(b2) 10% to 50% by weight of at least one polyalkylene oxide having a hydroxyl number of from 120 to 600 mg KOH/g, based on a difunctional and/or a trifunctional starter molecule, and an ethylene oxide content, based on a content of alkylene oxide, of from 0% to 40% by weight and
(b3) 0% to 30% by weight of at least one further polyalkylene oxide having a hydroxyl number of from 100 to 800 mg KOH/g, based on a difunctional to tetrafunctional starter molecule, which differs from the polyetherols (b1) and (b2),
based in each case on a total weight of components (b1) to (b3),
wherein a proportion of the components (b1) to (b3) is 70% to 100% by weight, based on a total weight of the component (b),
the method comprising using the adhesive (C) for bonding of thermal insulation material (B).
Composite elements of thermal insulation material, adhesive and outer layer
